(19) United States
(12) Patent Application Publication
(10) Pub. No.: US 2007/0292143 A1
(43) Pub. Date: Dec. 20, 2007

(54) Optical Re-Modulation in DWDM Radio-Over-Fiber Network

(75) Inventors: Jianjun Yu, West Windsor, NJ (US); Lei Xu, Princeton, NJ (US); Ting Wang, Princeton, NJ (US)

Correspondence Address: NEC LABORATORIES AMERICA, INC., 4 INDEPENDENCE WAY, Suite 200, PRINCETON, NJ, 08540, US

(73) Assignee: NEC LABORATORIES AMERICA, INC., Princeton, NJ (US)

(21) Appl. No.: 11/761,021

(22) Filed: Jun. 11, 2007

Related U.S. Application Data
(60) Provisional application No. 60/804,666, filed on Jun. 14, 2006.

(51) Int. Cl. H04B 10/04

(52) U.S. Cl. 398/188

(57) ABSTRACT

An apparatus includes multiple signal paths for optically converting an optical signal to multiples of the optical signal at different respective carrier frequencies for reducing interference between wireless transmissions of the multiples of the optical signal. Preferably, the converting includes a first modulator for modulating the optical signal into a first optical carrier and an initial first-order sideband signal with a frequency spacing twice that of the first optical carrier and a first interleaver for separating the first optical carrier and the initial first-order sideband signal. The converting also includes a second phase modulator for modulating the first optical carrier into a second optical carrier and a second first-order sideband signal with a frequency spacing twice that of the second optical carrier.

This application claims the benefit of U.S. Provisional Application No. 60/804,666, entitled “Reduction of Physical layer Interference in a DWDM Radio Over Fiber Network by using Multiple Time Remodulation”, filed on Jun. 14, 2006, the contents of which is incorporated by reference herein.

### BACKGROUND OF THE INVENTION

The present invention relates generally to optical communications, and, more particularly, to reduction of physical layer interference in dense wavelength division multiplexing DWDM radio-over-fiber network by using multiple time re-modulation.

The application of radio-over-fiber (ROF) for broadband wireless access has attracted much attention recently because it provides the mobile broadband services, wireless local area networks LANs, and fixed wireless access services such as Local Multipoint Distribution Service LMDS that uses microwave signals to transmit and receive data. A few key issues such as all-optical up-conversion, down-conversion and network architecture have been solved. However, one more important issue merits consideration in the future radio-over-fiber ROF network. Referring to the diagram 100 shown in FIG. 1, areas A, B and C are neighbouring channel transmission regions, 107_{ch1}, 107_{ch2} and 107_{ch3}. These adjacent channel regions include optical to electrical O/E converters and radio frequency RF transmitters, 109_{ch1}, 109_{ch2}, 109_{ch3}, that have overlapped wireless RF transmission areas. The wavelength division multiplexing WDM signals 101 are up-converted by using an external modulator 103 based on an optical carrier suppression (OCS) modulation scheme and the RF frequency (or only “RF”) is f. After up-converting to the frequency f the signals are separated or multiplexed by the arrayed waveguide grating AWG 105 as ch1, ch2 and ch3. The RF frequency of the optical mm-wave for all channels ch1, ch2 and ch3 is identical and equal to 2f, which means that the customer units in area A, B and C use the same RF frequency. When the wireless signals are broadcast in these areas, the customer unit in the overlapped area would accept two or three different signals which have the same RF frequency. After down-conversion, these signals would interfere with each other when the customer unit receives them.

If the RF carrier frequency in area A, B, and C can be set to different frequencies, the physical layer interference would be mitigated. For example, the RF carrier frequency in area A, B, and C can be set to 59 GHz, 59.5, and 60 GHz, respectively. In this way, only one RF frequency signal can be effectively down-converted at each customer unit in the overlapped region.

Accordingly, there is a need to overcome the problem of physical layer interference caused in a radio-over-fiber network with multiple channels at the same carrier frequency.

### SUMMARY OF THE INVENTION

In accordance with the invention, an apparatus includes multiple signal paths for optically converting an optical signal to multiples of said optical signal at different respective carrier frequencies for reducing interference between wireless transmissions of said multiples of said optical signal. In a preferred embodiment, the converting includes a first modulator for modulating the optical signal into a first optical carrier and an initial first-order sideband signal with a frequency spacing twice that of the first optical carrier and a first interleaver for separating the first optical carrier and the initial first-order sideband signal. The converting also includes a second phase modulator for modulating the first optical carrier into a second optical carrier and a second first-order sideband signal with a frequency spacing twice that of the second optical carrier.

In another aspect of the invention, a method includes optically converting an optical signal to multiples of said optical signal at different respective carrier frequencies for reducing interference between wireless transmissions of said multiples of said optical signal. Preferably, the converting includes modulating the optical signal into a first optical carrier and an initial first-order sideband signal with a frequency spacing twice that of the first optical carrier and separating the first optical carrier and the initial first-order sideband signal. The method further includes converting modulating the first optical carrier into a second optical carrier and a second first-order sideband signal with a frequency spacing twice that of the second optical carrier.

In yet another aspect of the invention, a method includes converting an optical signal into a first optical carrier and an initial first-order sideband signal with a frequency spacing twice that of the first optical carrier, and separating the first optical carrier and the initial first-order sideband signal for subsequent converting of the first optical carrier into a second optical carrier and a second first-order sideband signal with a frequency spacing twice that of the second optical carrier.

### BRIEF DESCRIPTION OF DRAWINGS

These and other advantages of the invention will be apparent to those of ordinary skill in the art by reference to the following detailed description and the accompanying drawings.

FIG. 1 is schematic of a dense wavelength division multiplexing DWDM radio-over-fiber network illustrating physical layer interference;

FIG. 2 is a schematic showing the inventive time re-modulation with different frequencies to reduce the physical layer interference shown in FIG. 1;

FIG. 3 is a diagram of an experimental setup for two time modulation with a RF frequency of 20 and 19.5 GHz in accordance with the present invention, with inserted optical spectra at a resolution of 0.01 nm;

FIG. 4 shows optical eye diagrams (a), (b), (c) and (d) (100 ps/div) after up conversion at respective points (a), (b), (c) and (d) in FIG. 3; and

FIG. 5 is a graph of bit-error-rate BER curves for the experimental setup of FIG. 3.

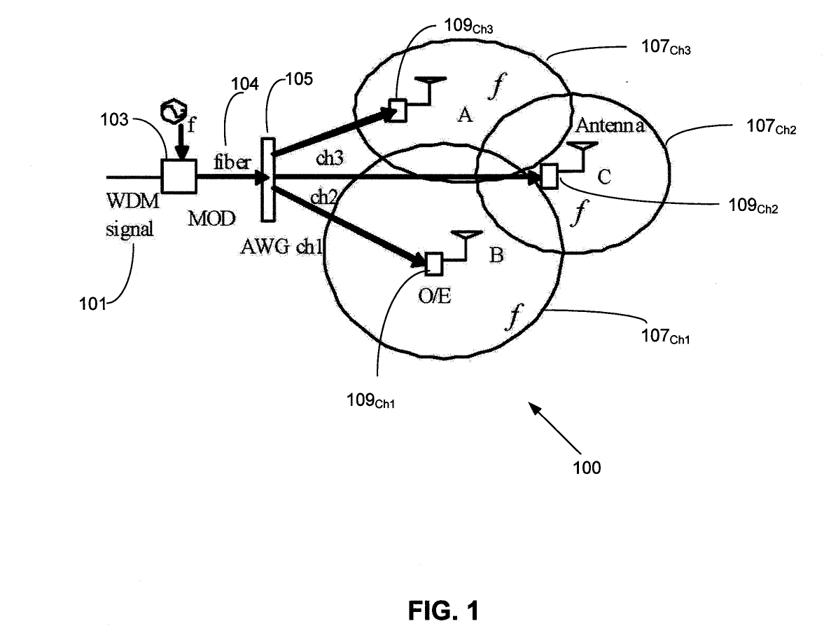

### DETAILED DESCRIPTION

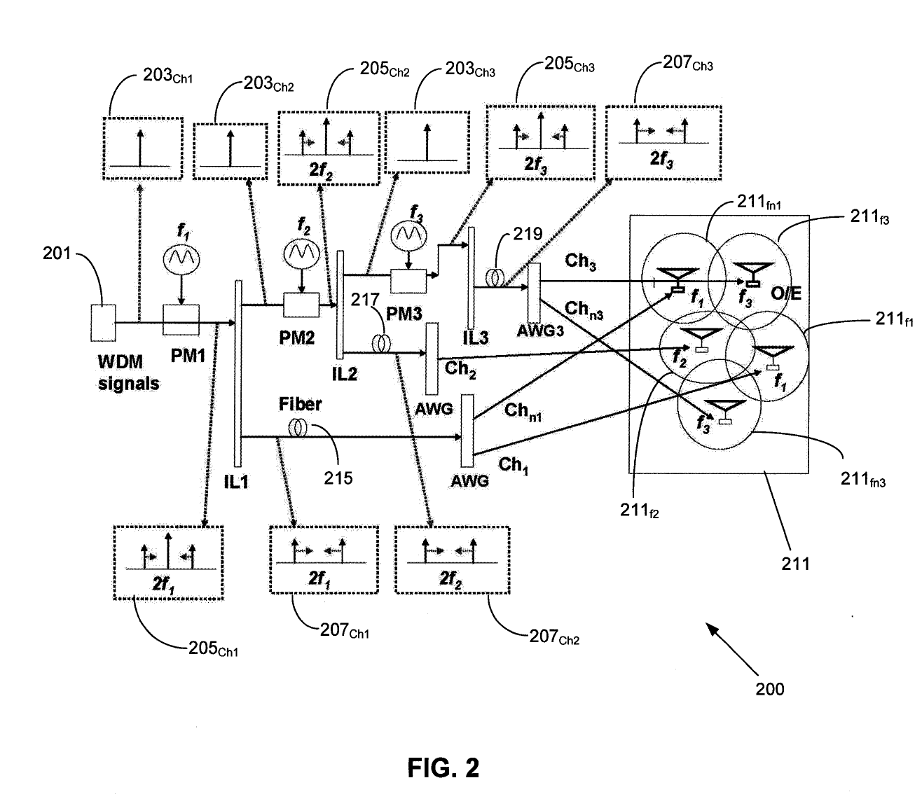

The schematic 200 of FIG. 2 shows an exemplary embodiment of an inventive all optical carrier re-modulation to different carrier frequencies for reducing the physical layer interference in overlapped transmission regions. A phase modulation PM1, PM2, PM3 is used along with interleaving IL1, IL2, IL3 to realize the DWDM signal up-conversion. After modulation of the incoming optical signal carrier 203_{ch1}, 203_{ch2}, 203_{ch3} driven by a small RF signal with frequency f₁, f₂, f₃ the optical spectrum of each channel contains an optical carrier and the first order sideband signal 205_{ch1}, 205_{ch2}, 205_{ch3} with a respective frequency spacing 2f₁, 2f₂, 2f₃ as shown in FIG. 2. Then an interleaver IL1, IL2 is used to separate out the remaining optical carrier 203_{ch2}, 203_{ch3} and the first-order sideband signal 207_{ch1}, 207_{ch2}, 207_{ch3}. At the final wireless transmission stage 211, with optical-to-electrical conversions 211_{f1}, 211_{f2}, 211_{f3}, 211_{fn1}, 211_{fn3} where the re-modulated signals are transmitted wirelessly, the carrier frequencies of the transmitted signals in overlapped regions shown are different and can be selectively filtered out by tuning in the desired channel.

Referring again to FIG. 2, there are three distinct paths shown: a first path PM1, IL1, fiber link 215 and arrayed waveguide grating AWG1; a second path PM2, IL2, fiber link 217, arrayed waveguide grating AWG2; and a third path PM3, IL3, fiber link 219, arrayed waveguide grating AWG3.

In the first path, after modulation by the phase modulator PM1 driven by a small RF signal with frequency (f₁), the optical spectrum of the channel only contains an optical carrier and the first order sideband signal 205_{ch1} with a frequency spacing of 2f₁. Then an interleaver IL1 separates out the remaining optical carrier 203_{ch2} from the first-order sideband signal 207_{ch1}. The remaining two tones of the first order sideband signal 207_{ch1} generate an optical millimeter wave (mm-wave). This optical millimeter wave is sent over a fiber link 215 to an array waveguide grating AWG1 which multiplexes the optical signal as first channel ch₁ at a carrier frequency 2f₁ to multiple optical-to-electrical converters 211_{f1}, 211_{fn1} for wireless transmission. Since all ch₁ transmissions are on the same carrier frequency, the wireless transmission regions 211_{f1}, 211_{fn1} transmitting on ch1 should be apart enough so there is no overlap in their wireless transmission regions.

The remaining optical carrier 203_{ch2} from the first interleaver IL1 is re-modulated by the second phase modulator PM2 driven by a second RF frequency f₂. After the second phase modulation PM2 the optical spectrum contains an optical carrier and the first-order sideband signal 205_{ch2} with a spacing of 2f₂. The second interleaver IL2 separates out the optical carrier 203_{Ch3} from the first-order sideband signal 207_{ch2}. The first-order sideband signal or optical millimeter wave (mm-wave) 207_{ch2} provided by the second interleaver IL2 is sent over a fiber link 217 to an array waveguide grating AWG2 which multiplexes the optical mm-wave 207_{ch2} as channel ch₂ on a carrier frequency 2f₂ to an optical-to-electrical converter for wireless transmission. Since the ch₂ transmission is on a different carrier frequency than the ch₁ transmission there is no interference between their respective transmission regions 211_{f2} for ch₂ and regions 211_{f1}, 211_{fn1} for ch₁.

The remaining optical carrier 203_{ch3} from the second interleaver IL2 is modulated by a third phase modulator PM3 driven by a third RF frequency f₃ to produce an optical carrier and first order sideband signal 205_{ch3}. The optical carrier is separated out by the third interleaver IL3 to leave only the first order sideband signal 207_{ch3}. After the third interleaver IL, the optical mm-wave, i.e., first order sideband signal 207_{ch3} at frequency 2f₃, is sent over a fiber link 219 to an array waveguide grating AWG3 which multiplexes the millimeter wave as channel ch₃ on a carrier frequency 2f₃ to optical-to-electrical converters for wireless transmission in regions 211_{f3}, 211_{fn3}. Since the ch₃ transmission is on a different carrier frequency than the chi and ch₂ transmissions there is no interference between their respective transmission regions 211_{f2} for ch₂, transmission regions 211_{f1}, 211_{fn1} for ch₁ and transmission regions 211_{f3}, 211_{fn3} for ch₃.

The exemplary embodiment of FIG. 2 demonstrates that the successive phase modulation and interleaving IL can be used for multiple wavelength operation to realize DWDM signal multi-time re-modulation. When these signals are delivered to the optical-to-electrical converter, arrayed waveguide grating (AWG) can be used to route the optical mm-wave to different antennas, and make the each antenna at an overlapped region transmit at a different RF carrier frequency. The elements shown in the schematic 200 of FIG. 2 can be physically located or grouped in a variety of configurations. The preferred physical location would be to have the phase modulator PM1, PM2, and PM3 and interleaver IL1, IL2, and IL3 located in a central office along with the signal source generator 201. The fiber links 215, 217 and 219 can be from the central office to a remote station containing the arrayed waveguide grating AWG1, AWG2, and AWG3.

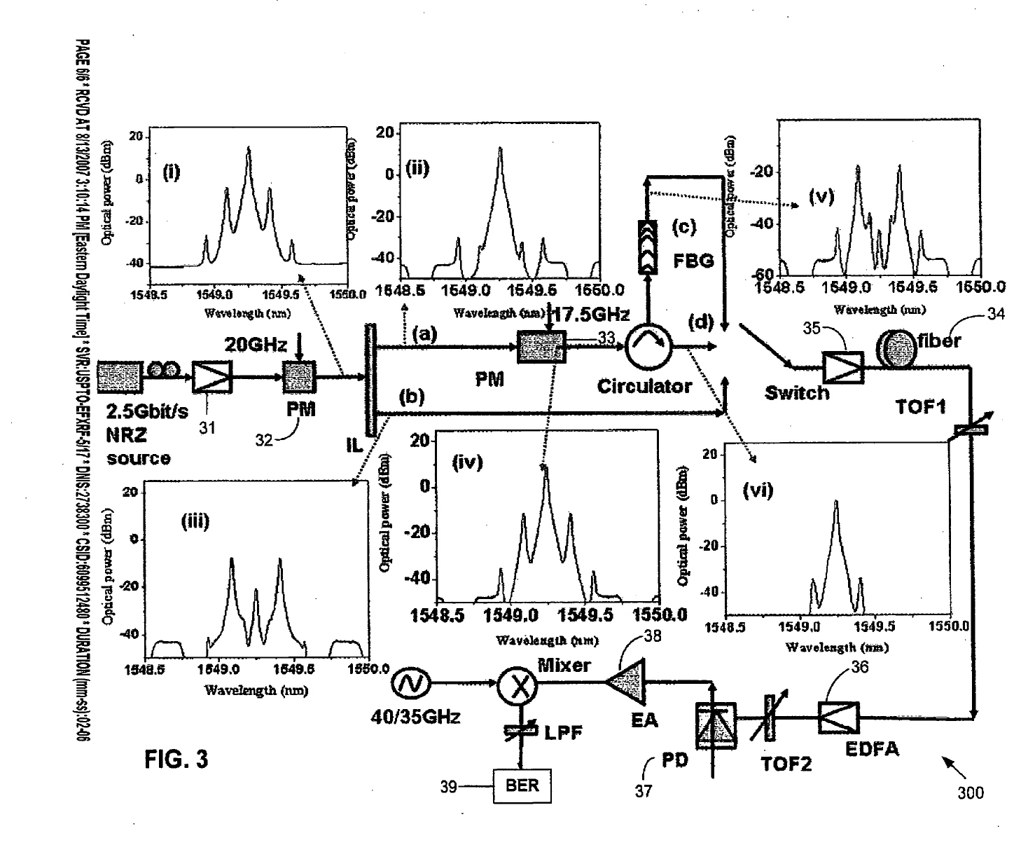

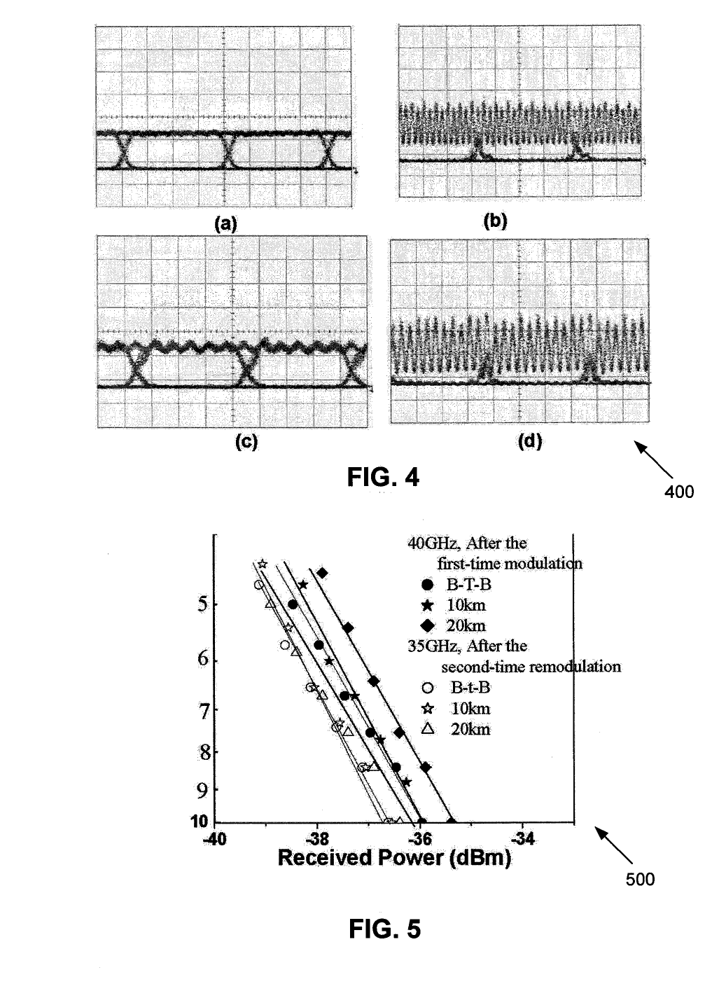

An experiment setup 300 for generating optical mm-wave signals at different RF frequencies by using multiple time re-modulation in accordance with the invention is shown in FIG. 3. FIG. 4 shows corresponding optical eye diagrams 400 (100 ps/div) after up-conversion at different points labeled in FIG. 3. Eye diagrams of (a), (b), (c) and (d) are obtained from points (a), (b), (c) and (d), respectively, noted in the experimental setup in FIG. 3.

A distributed feedback laser DFB laser at 1549.3 nm was modulated by a LN Mach-Zehnder modulator (LN-MZM) driven by a 2.5 Gbit/s electrical signal with a PRBS length of 2³¹−1. Then this 2.5 Gbit/s base-band non-return-to-zero NRZ source was amplified EDFA (erbium-doped fiber amplifier) 31 and then modulated by a phase modulator 32 driven by a 20 GHz sinusoidal clock with peak-to-peak amplitude of 3V. The optical spectrum after the phase modulator PM 32 is shown in FIG. 3 as inset (i). The half-wave voltage of this phase modulator is 8V. Since the driving voltage is much smaller than half-wave voltage of the phase modulator, the second order sideband is 25 dB lower than the first order sideband; therefore the second order sidebands have little effect on the transmission of the optical mm-wave in single mode fibers SMF.

An optical interleaver IL with two output ports, shown as (a) and (b) in FIG. 3, and 25 GHz bandwidth was used to suppress the optical carriers and convert the modulated DWDM lightwaves to DWDM optical mm-waves. After the optical interleaver IL, the carrier suppression ratio is larger than 15 dB as shown in inset (iii) in FIG. 3, and the repetition frequency of the optical mm-wave is 40 GHz. The corresponding eye diagram is shown in FIG. 4(b). The total power of the optical mm-wave signals is larger than 1 dBm. The remaining optical carrier from the other port (a) of the interleaver is shown in FIG. 3 as inset (ii). The eye diagram of the separated optical carrier is shown in FIG. 4(a). There only exists the basement signal, and the RF carrier is negligible.

The remaining optical carrier was re-modulated by the second phase modulator PM 33 with a frequency of the RF signal to drive the phase modulator at 17.5 GHz. The optical spectrum after the second time modulation is shown in FIG. 3 as inset (iv). The output from the second time modulation is passed through an optical circulator to a fiber Bragg grating (FBG), path (c) in FIG. 3, to separate the remaining optical carrier and the first sideband signals. The optical spectra after this separation are shown in FIG. 4 as inset (v) and (vi). In this way, a 35 GHz optical mm-wave signal was generated and realized with the second time modulation. The eye diagram after the second time modulation is shown in FIG. 4(d), where it can be seen that the repetitive frequency of the RF signal is 35 GHz.

Through switching the optical mm-waves, either 40 GHz or 35 GHz, were amplified 35 by an EDFA to obtain a power of 5 dBm and then they were transmitted over variable length single mode fiber SMF 34. At the receiver end, the optical mm-wave signals were filtered by a tunable optical filter TOF1 with a bandwidth of 1.2 nm, then they were pre-amplified by an EDFA 36 with a gain of 30 dB at small signal, and then filtered by a tunable optical filter TOF2 with a bandwidth of 0.5 nm before optical-to-electrical O/E conversion via a PIN PD 37 with a 3 dB bandwidth of 60 GHz. The converted electrical signal was amplified by an electrical amplifier EA 38 with a bandwidth of 10 GHz centered at 40 GHz. An electrical LO signal at 40 GHz was generated by using a frequency multiplier from 10/8.75 to 40/35 GHz. The electrical LO signal and a mixer were used to down-convert the electrical mm-wave signal. The down-converted 2.5 Gbit/s signal was detected by a bit error rate BER tester 39.

The fiber length was changed and the BER performance of the optical mm-wave after the first modulation 32 and the second modulation 33 was measured. The measured BER curves 500 are shown in FIG. 5. The power penalties for the 40 GHz mm-wave after the first-time modulation and transmission over 10 and 20 km are 0 and 0.7 dB, respectively. While the power penalties for the 35 GHz millimeter wave after the second-time re-modulation and after transmission over 10 and 20 km are 0 and 0.5 dB, respectively. These results show that the optical mm-wave signals after the second-time re-modulation have very good transmission performance.

The present invention has been shown and described in what are considered to be the most practical and preferred embodiments. For example, the exemplary embodiment employed three all optical time re-modulation paths to provide transmissions with three different carrier frequencies f1, f2, f2, however, that departures may be made there from and that obvious modifications will be implemented by those skilled in the art. It will be appreciated that those skilled in the art will be able to devise numerous arrangements and variations which, although not explicitly shown or described herein, embody the principles of the invention and are within their spirit and scope.

What is claimed is:

1. An apparatus comprising:
multiple signal paths for optically converting an optical signal to multiples of said optical signal at different respective carrier frequencies for reducing interference between wireless transmission of said multiples of said optical signal.

2. The apparatus of claim 1, wherein said converting comprises a first modulator for modulating said optical signal into a first optical carrier and an initial first-order sideband signal with a frequency spacing twice that of the first optical carrier and a first interleaver for separating the first optical carrier and the initial first-order sideband signal.

3. The apparatus of claim 2, wherein said converting comprises a second phase modulator for modulating the first optical carrier into a second optical carrier and a second first-order sideband signal with a frequency spacing twice that of the second optical carrier.

4. The apparatus of claim 3, wherein said converting comprises a second interleaver for separating the second optical carrier and the second first-order sideband signal.

5. The apparatus of claim 4, wherein said converting comprises a third phase modulator for modulating the second optical carrier into a third optical carrier and a third first-order sideband signal with a frequency spacing twice that of the third optical carrier.

6. The apparatus of claim 5, wherein said converting comprises a third interleaver for separating the third first-order sideband signal.

7. The apparatus of claim 1, wherein said optical converting comprises a first modulator for converting an optical signal to a first optical carrier and sideband signal centered about the first optical carrier, a filter for separating the first optical carrier, and a second modulator for converting the first optical carrier to a second optical carrier with sideband signal centered about the second optical carrier.

8. A method comprising:
optically converting an optical signal to multiples of said optical signal at different respective carrier frequencies for reducing interference between wireless transmission of said multiples of said optical signal.

9. The method of claim 8, wherein said converting comprises modulating said optical signal into a first optical carrier and an initial first-order sideband signal with a frequency spacing twice that of the first optical carrier and separating the first optical carrier and the initial first-order sideband signal.

10. The method of claim 9, wherein said converting comprises modulating the first optical carrier into a second optical carrier and a second first-order sideband signal with a frequency spacing twice that of the second optical carrier.

11. The method of claim 10, wherein said converting comprises separating the second optical carrier and the second first-order sideband signal.

12. The method of claim 11, wherein said converting comprises a modulating of the second optical carrier into a third optical carrier and a third first-order sideband signal with a frequency spacing twice that of the third optical carrier.

13. The method of claim 12, wherein said converting comprises a separating the third first-order sideband signal.

14. The method of claim 8, wherein said optical converting comprises a first converting of the optical signal to a first optical carrier and sideband signal centered about the first optical carrier, separating the first optical carrier, and a converting the first optical carrier to a second optical carrier with sideband signal centered about the second optical carrier.

15. A method comprising:
converting an optical signal into a first optical carrier and an initial first-order sideband signal with a frequency spacing twice that of the first optical carrier, and
separating the first optical carrier and the initial first-order sideband signal for subsequent converting of the first optical carrier into a second optical carrier and a second first-order sideband signal with a frequency spacing twice that of the second optical carrier.
